(19) United States
(12) Patent Application Publication
(10) Pub. No.: US 2007/0043899 A1
(43) Pub. Date: Feb. 22, 2007

(54) Data transfer device and data transfer method

(75) Inventor: Tomoki Kurata, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/281,493

(22) Filed: Nov. 18, 2005

(30) Foreign Application Priority Data
Aug. 19, 2005 (JP) 2005-238728

(51) Int. Cl. G06F 12/00

(52) U.S. Cl. 711/103

(57) ABSTRACT

A data transfer device for transferring data from a first sector of a flash memory to a second sector of the flash memory, the data transfer device comprising: a reading unit that reads data from the first sector; and a writing unit that writes the data read by the reading unit in the second sector.

### CROSS-REFERENCE TO RELATED APPLICATIONS

This application is based upon and claims the benefit of priority from Japanese Patent Application No. 2005-238728, filed on Aug. 19, 2005, the entire contents of which are incorporated herein by reference.

### BACKGROUND OF THE INVENTION

1. Field of the Invention

The present invention relates to a technology for updating data stored in a flash memory.

2. Description of the Related Art

Conventionally, there are mainly two techniques for updating a portion of data stored in a sector of a flash memory. In the first technique, all the data stored in the sector, which includes data to be updated, are transferred to another sector within the same flash memory. In the second technique, all the data stored in the sector is read out to a RAM, and written back to the same sector from the RAM after the sector erase. In either technique, data transfer is performed by a CPU.

In the second technique, however, data can be lost if a reset or a power-off occurs after the start of the sector erase and before the completion of data writing. Therefore, in general, the first technique is preferred.

In the second technique, a DMA controller can be used instead of the CPU to perform data transfer between the flash memory and the RAM. There has been suggested a DMA controller that automatically adds a write command to data transferred from the RAM to the flash memory. However, the DMA controller requires a buffer (such as the RAM) where data is temporarily stored; because, the DMA controller cannot transfer the data directly from one sector to anther sector within the same flash memory.

Other techniques related to data transfer between different memories are disclosed, for example, in Japanese Patent Application Laid-Open Nos. H8-202649 and H11-316716.

On the other hand, in the first technique, the CPU has to switch the mode of the flash memory between a read mode and a write mode and to input a write command to the flash memory. Furthermore, the CPU has to perform data polling for detecting the completion of data writing. In other words, the CPU has to be involved in data transfer at all times, thereby making data transfer program more complicated.

Moreover, a long polling interval makes the write time longer because of the delay in detecting the completion of data writing. On the other hand, a short polling interval increases the frequency of access to the flash memory, and therefore increases power consumption and the overhead time; because, other tasks executed by the CPU are frequently interrupted by the data polling.

### SUMMARY OF THE INVENTION

It is an object of the present invention to at least solve the problems in the conventional technology.

A data transfer device according to an aspect of the present invention is a data transfer device for transferring data from a first sector of a flash memory to a second sector of the flash memory. The data transfer device includes: a reading unit that reads data from the first sector; and a writing unit that writes the data read by the reading unit in the second sector.

A data transfer device according to another aspect of the present invention is a data transfer device for transferring data from a first sector of a flash memory to a second sector of the flash memory. A first data is stored in the first sector. The data transfer device includes: a storing unit that stores a second data that is an updated data of the first data; a reading unit that reads the second data from the storing unit; and a writing unit that writes the second data read by the reading unit in the second sector.

A method according to still another aspect of the present invention is a method of transferring data from a first sector of a flash memory to a second sector of the flash memory. The method includes: reading data from the first sector; and writing the data read at the reading in the second sector.

A method according to still another aspect of the present invention is a method for transferring data from a first sector of a flash memory to a second sector of the flash memory. A first data is stored in the first sector. The method includes: storing a second data that is an updated data of the first data in a database; reading the second data from the database; and writing the second data read at the reading in the second sector.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a data transfer device according to a first embodiment of the present invention;

FIG. 2 is a diagram of a hardware configuration of the data transfer device shown in FIG. 1;

FIG. 3 is a flowchart of data transfer processing according to the first embodiment;

FIG. 4 is a block diagram of a data transfer device according to a second embodiment of the present invention;

FIG. 5 is a diagram of a hardware configuration of a flash memory interface included in the data transfer device shown in FIG. 4;

FIG. 6 is a flowchart of data transfer processing according to the second embodiment; and

FIG. 7 is a flowchart of data read processing shown in FIG. 6.

### DETAILED DESCRIPTION OF THE PREFERRED EMBODIMENTS

Exemplary embodiments of the present invention will be explained in detail with reference to the accompanying drawings.

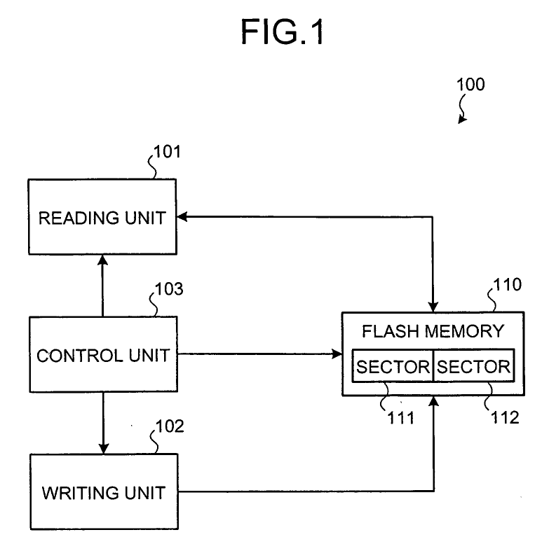

FIG. 1 is a block diagram of a data transfer device according to a first embodiment of the present invention. A data transfer device 100 reads/writes data from/to a flash memory 110. The flash memory 110 is a nonvolatile memory in which data is electrically erased/written in units of sectors and retained without power supply. The mode of the flash memory 110 can be switched between a write mode, in which data is written in the flash memory 110, and a read mode, in which data is read out from the flash memory 110. The flash memory 110 may be built in or attached to the data transfer device 100. The flash memory 110 may be detachable from the data transfer device 100.

As shown in FIG. 1, the data transfer device 100 includes a reading unit 101, a writing unit 102, and a control unit 103. The reading unit 101 reads data stored at a designated address in a first sector (hereinafter, “source sector”) 111 of the flash memory 110 that is in the read mode.

The writing unit 102 writes the data read by the reading unit 101 into a second sector (hereinafter, “destination sector”) 112 of the flash memory 110, the mode of which is switched from the read mode to the write mode. Thus, the data stored in the source sector 111 is transferred to the destination sector 112.

The control unit 103 controls the switch-over between the read mode and the write mode of the flash memory 110. Specifically, the mode of the flash memory 110 is switched from the read mode to the write mode when the reading unit 101 finishes reading data from the source sector 111. On the other hand, the mode of the flash memory 110 is switched from the write mode to the read mode when the writing unit 102 finishes writing data in the destination sector 112. After data stored at a certain address of the source sector 111 is read out by the reading unit 101 and written in the destination sector 112 by the writing unit 102, another data stored at another address of the source sector 111 is transferred to the destination sector 112.

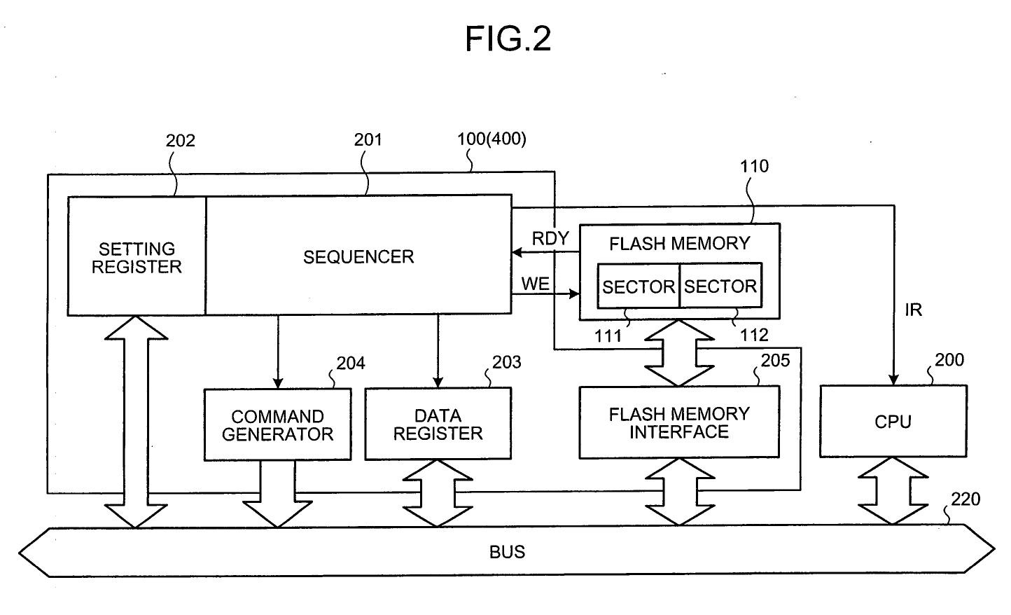

FIG. 2 is a diagram of a hardware configuration of the data transfer device 100. As shown in FIG. 2, both the data transfer device 100 and a CPU 200 are connected to a bus 220. The flash memory 110 includes a plurality of sectors each of which being a unit of data erasing or data writing, although only two sectors (namely, the source sector 111 and the destination sector 112) are shown in FIG. 2.

The flash memory 110 receives a write-enable signal WE from the data transfer device 100 to switch between the read mode and the write mode. Furthermore, when the data writing is completed in the write mode, the flash memory 110 transmits a ready signal RDY to the data transfer device 100.

A sequencer 201 controls overall operations of the data transfer device 100. Specifically, the sequencer 201 performs data read/write control on the flash memory 110, a control on a command generator 204, transmission of the write-enable signal WE to the flash memory 110, and transmission of an interrupt request signal IR to the CPU 200.

For example, when receiving the ready signal RDY from the flash memory 110, the sequencer 201 transmits a write-enable signal WE (WE=0) indicating data reading to the flash memory 110, thereby switching the mode of the flash memory from the write mode to the read mode. When the data reading is completed, the sequencer 201 transmits a write-enable signal WE (WE=1) indicating data writing to the flash memory 110, thereby switching the mode of the flash memory 110 from the read mode to the write mode.

Furthermore, when transmitting the write-enable signal (WE=1), the sequencer 201 instructs the command generator 204 to issue a write command. After all data stored in the source sector 111 are transferred to the destination sector 112, the sequencer 201 transmits an interrupt request signal IR indicating the completion of data transfer to the CPU 200.

A setting register 202 stores a source address in the source sector 111 and a destination address in the destination sector 112. The source address and the destination address are set, for example, by the CPU 200 or the sequencer 201.

A data register 203 temporarily stores the data that is read from the source sector 111 and written in the destination sector 112 under the control of the sequencer 201.

The command generator 204 issues the write command to the flash memory 110 upon receiving the instruction from the sequencer 201. The destination address in the destination sector 112 is designated, for example, by the write command including the address that is set in the setting register 202 as the destination address. A flash memory interface 205 transfers data between the flash memory 110 and the data register 203.

The reading unit 101, the writing unit 102, and the control unit 103 shown in FIG. 1 are implemented by the sequencer 201, the setting register 202, the data register 203, the command generator 204, and the flash memory interface 205 shown in FIG. 2.

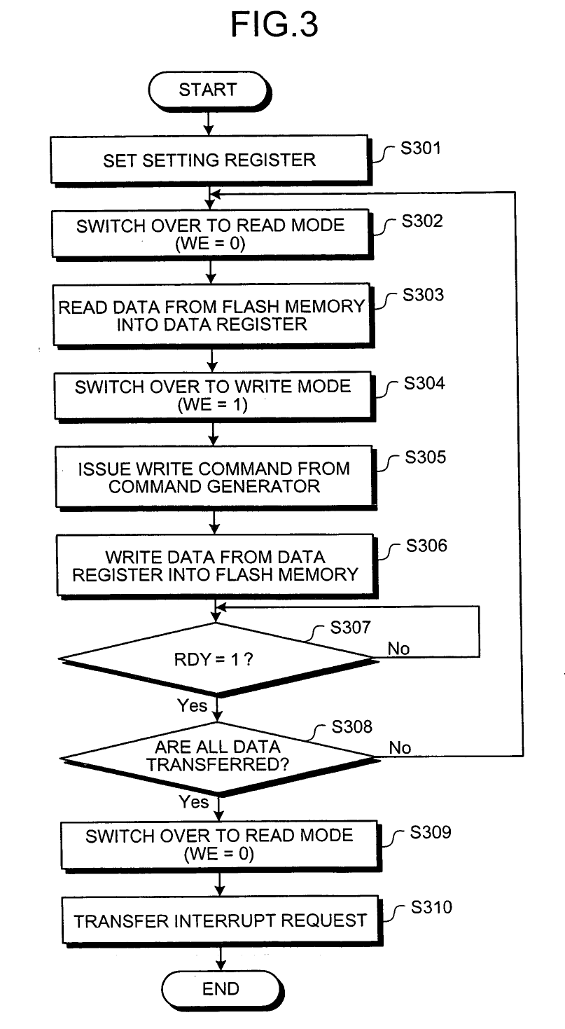

FIG. 3 is a flowchart of data transfer processing performed by the data transfer device 100. The source address in the source sector 111 and the destination address in the destination sector 112 are set in the setting register 202 (Step S301).

The sequencer 201 then transmits a write-enable signal WE (WE=0) to the flash memory 110, thereby switching the mode of the flash memory 110 to the read mode (Step S302). The data stored at the source address within the source sector 111 is read (Step S303). Specifically, the source address set in the setting register 202 is transmitted to the flash memory 110, and the data stored at the source address is transferred to the data register 203, where the data is temporarily stored before being transferred to the destination address.

When the data reading is completed, the sequencer 201 transmits a write-enable signal WE (WE=1) to the flash memory 110, thereby switching the mode of the flash memory 110 to the write mode (Step S304). The sequencer 201 also instructs the command generator 204 to issue the write command (Step S305). Then the data temporarily stored in the data register 203 is written at the destination address, which is designated by the write command, in the destination sector 112 of the flash memory 110 (Step S306).

The sequencer 201 waits for a ready signal RDY (RDY=1) from the flash memory 110 (Step S307: No). When receiving the ready signal RDY (RDY=1) (Step S307: Yes), the sequencer 201 determines whether the process from Step S302 to Step S306 is executed for all the source addresses set in the setting register 202 (Step S308).

When the process is not executed for all the source addresses (Step S308: No), the process returns to Step S302, and a write-enable signal WE (WE=0) is transmitted to the flash memory 110 to switch the mode thereof to the read mode. As a result, the data that is stored in the source sector 111 but has not been transferred to the destination sector 112 is transferred to the destination sector 112.

On the other hand, if the process has been executed for all the source addresses (Step S308: Yes), a write-enable signal WE (WE=0) is transmitted to the flash memory 110 to switch the mode thereof to the read mode (Step S309), and the interrupt request signal IR indicating the completion of data transfer is transmitted to the CPU 200 (Step S310).

In other words, the sequencer 201 repeatedly reads/writes data from/in the flash memory 110 until all the data to be transferred are transferred. When the transfers of all data are completed, the sequencer 201 generates the interrupt request to the CPU 200.

According to the first embodiment, stable data transfer is achieved in which the data stored in the flash memory 110 would not lost, because the data is transferred through the data register 203 of the data transfer device 100.

Furthermore, the data transfer can be performed without involving the CPU 200, because the switch-over control between the read mode and the write mode of the flash memory 110 is performed by the sequencer 201 using the write-enable signal WE, and the write command is issued by the command generator 204. As a result, the efficiency of data transfer can be increased. Moreover, a speed-up of data transfer is achieved because the occupation of bus 220 by the CPU 200 is reduced.

Moreover, the completion of data writing into the flash memory 110 can be detected by the ready signal RDY, thereby rendering the data polling unnecessary and therefore increasing the efficiency of data transfer.

Thus, according to the first embodiment, data can be transferred stably and efficiently between different sectors within the same flash memory 110.

According to the first embodiment, data stored in the source sector 111 is transferred to the destination sector 112. According to a second embodiment of the present invention, however, original data (data before update) stored in the source sector 111 is updated to become updated data (data after update), and the updated data is transferred to the destination sector 112. In the following explanation, the same components as those of the first embodiment are assigned with the same reference numerals, and the descriptions thereof will be omitted.

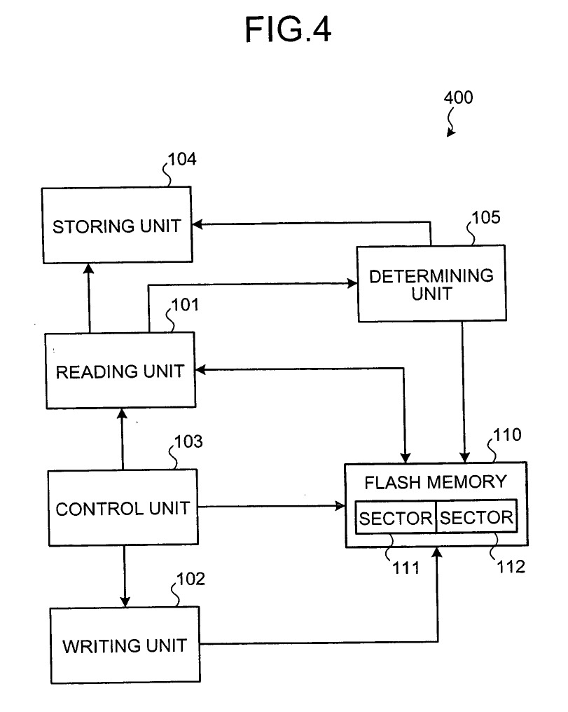

FIG. 4 is a block diagram of a data transfer device according to a second embodiment of the present invention. As shown in FIG. 4, a data transfer device 400 includes a storing unit 104 and a determining unit 105 in addition to the reading unit 101, the writing unit 102, and the control unit 103, which have been described in the first embodiment.

A set of an address in the source sector 111 and the updated data corresponding to the original data stored at the address is stored in the storing unit 104 before the reading unit 101 starts to read data.

The determining unit 105 determines whether an address in the source sector 111 designated as a source address matches any one of the addresses stored in the storing unit 104. When the addresses do not match, data stored at the designated source address of the flash memory 110 is read.

On the other hand, when the addresses match, the updated data corresponding to the designated address is read from the storing unit 104 by the reading unit 101, and written in the destination sector 112 by the writing unit 102. Thus, while the original data is retained in the source sector 111, the updated data corresponding to the original data is transferred to the destination sector 112 from the storing unit 104.

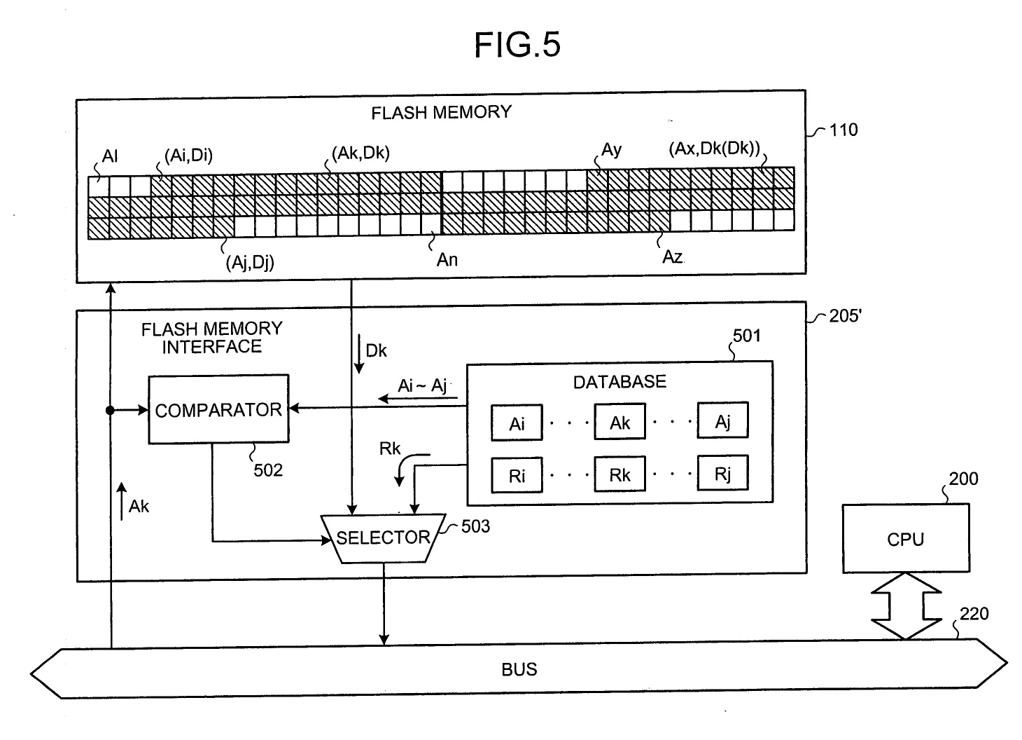

A hardware configuration of the data transfer device 400 according to the second embodiment is the same as that of the data transfer device 100 according to the first embodiment, except for a flash memory interface 205′ corresponding to the flash memory interface 205. FIG. 5 is a diagram of the hardware configuration of the flash memory interface 205′.

As shown in FIG. 5, in the source sector 111 of the flash memory 110, original data are stored from address A1 to address An. Assume that a portion of the original data, namely, original data Di to Dj (indicated by the hatched region in FIG. 5) stored at addresses Ai to Aj, respectively, are to be updated.

As shown in FIG. 5, the flash memory interface 205′ includes a database 501, a comparator 502, and a selector 503. The CPU 200 stores a set of the address Ai . . . Aj of the original data Di . . . Dj and the updated data Ri . . . Rj updated from the original data Di . . . Dj in the database 501.

The comparator 502 is a logic circuit that compares an address Ak transmitted from the data transfer device 400 with each of the addresses Ai to Aj stored in the database 501. The selector 503 is a logic circuit that switches, when receiving a switch signal from the comparator 502, between the database 501 and the flash memory 110 so that either the database 501 or the flash memory 110 is connected to the sequencer 201 through the selector 503.

When the address Ak matches any one of the addresses Ai to Aj stored in the database 501, the comparator 502 transmits a switch signal for connecting the database 501 and the sequencer 201 to the selector 503. Then the updated data Rk corresponding to the address Ak is read from the database 501 into the data register 203, and written at a destination address Ax, which is set in the, setting register 202, of the destination sector 112. Thus, the updated data Rk corresponding to the original data Dk stored at the address Ak of the source sector 111 is transferred to the address Ax of the destination sector 112.

On the other hand, when the address Ak does not match any one of the addresses Ai to Aj stored in the database 501, the comparator 502 transmits a switch signal for connecting the flash memory 110 and the sequencer 201 to the selector 503. Then the data Dk stored at the address Ak of the source sector 111 of the flash memory 110 is read into the data register 203, and written at the destination address Ax, which is set in the setting register 202, of the destination sector 112. Thus, the original data Dk stored at the address Ak of the source sector 111 is transferred to the address Ax of the destination sector 112.

The storing unit 104 shown in FIG. 4 is implemented by the database 501 shown in FIG. 5, and the determining unit 105 shown in FIG. 4 is implemented by the comparator 502 and the selector 503 shown in FIG. 5.

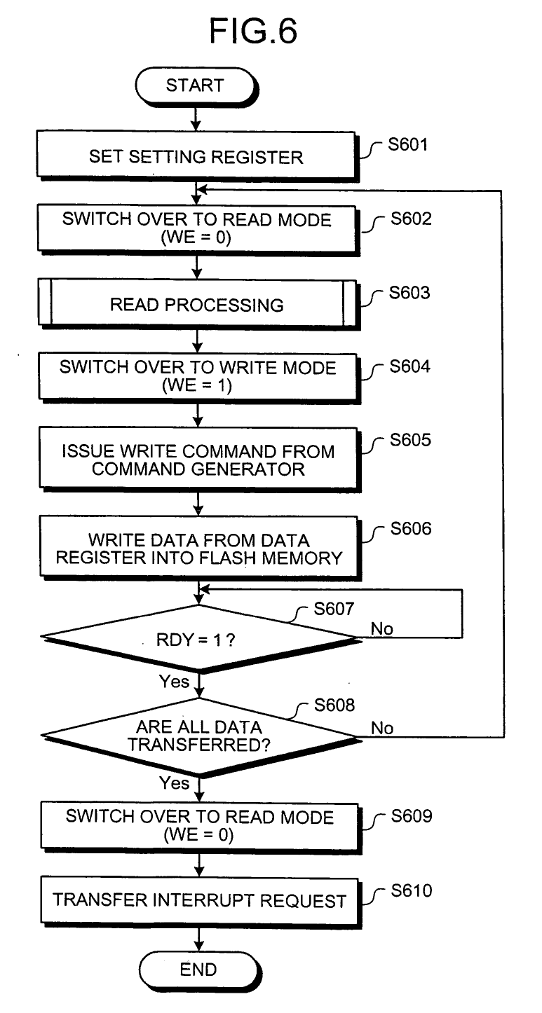

FIG. 6 is a flowchart of data transfer processing performed by the data transfer device 400 according to the second embodiment of the invention. Assume that the addresses Ai to Aj in the source sector 111 at which the original data Di to Dj are stored, respectively, and the updated data Ri to Rj corresponding to the original data Di to Dj, respectively, are previously stored in the database 501 by the CPU 200.

As shown in FIG. 6, the addresses Ai to Aj of the source sector 111 at which the original data Di to Dj are stored and destination addresses Ay to Az in the destination sector 112 for the updated data Ri to Rk are set in the setting register 202 (Step S601).

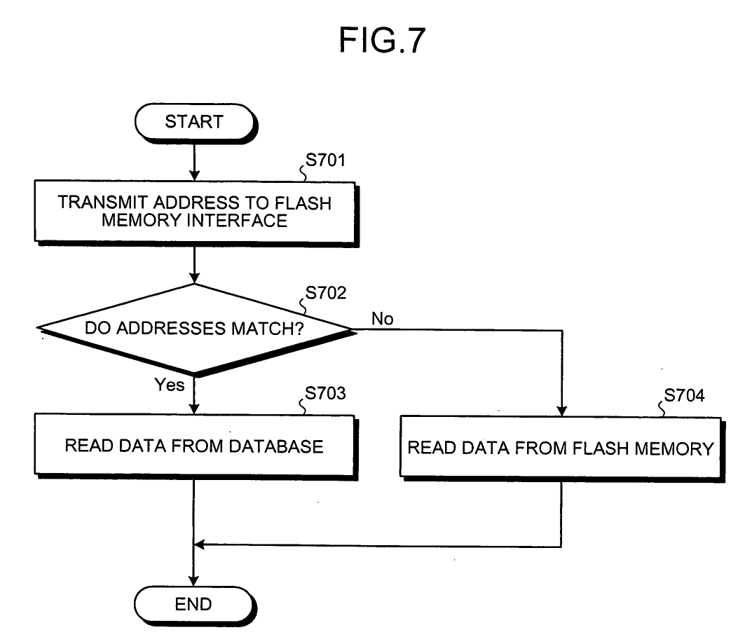

Next, the write-enable signal WE (WE=0) is transmitted to the flash memory 110 to switch over the mode of the flash memory 110 to the read mode (Step S602). Then data read processing, which will be explained in detail later with reference to FIG. 7, is executed (Step S603).

When the data reading is completed, the sequencer 201 transmits the write-enable signal WE (WE=1) to the flash memory 110 to switch over the mode of the flash memory 110 to the write mode (Step S604). The sequencer 201 also instructs the command generator 204 to issue the write command (Step S605). Then the data temporarily stored in the data register 203 is written into the destination sector 112 of the flash memory 110 at the destination address Ax designated by the write command (Step S606).

The sequencer 201 waits for the ready signal (RDY=1) from the flash memory 110 (Step S607: No). When receiving the ready signal RDY (RDY=1) (Step S607: Yes), the sequencer 201 determines whether all of the data Di to Dj or Ri to Rj corresponding to the source addresses Ai to Aj, which are set in the setting register 202, have been transferred (Step S608).

When there still remains data to be transferred to the flash memory interface 205 (Step S608: No), the process returns to Step S602 and the sequencer 201 transmits the write-enable signal WE (WE=0) to the flash memory 110.

On the other hand, when all data have been transferred to the flash memory interface 205 (Step S608: Yes), the sequencer 201 transmits the write-enable signal WE (WE=0) to the flash memory 110, thereby switching the mode of the flash memory 110 to the read mode (Step S609). Then, an interrupt request signal IR indicating the completion of data transfer is transmitted to the CPU 200 (Step S610).

In other words, the sequencer 201 repeatedly reads/writes data from/in the flash memory 110 until all the data to be transferred are transferred. When the transfers of all data are completed, the sequencer 201 generates the interrupt request to the CPU 200.

FIG. 7 is a flowchart of the data read processing shown in FIG. 6 (Step S603). Following Step S602 of FIG. 6, the address Ak, which is selected from among all the source addresses Ai to Aj set in the setting register 202, is transmitted to the comparator 502 of the flash memory interface 205′ (Step S701).

The comparator 502 determines whether the input address Ak matches any one of the addresses Ai to Aj of the source sector 111 stored in the database 501 (Step S702). When the address Ak matches any one of the addresses Ai to Aj (Step S702: Yes), the selector 503 connects the database 501 and the sequencer 201, and the updated data Rk corresponding to the address Ak is read from the database 501 to be stored in the data register 203 (Step S703).

Then the process proceeds to Step S604 shown in FIG. 6, in which the updated data Rk stored in the data register 203 is transferred to the address Ax in the destination sector 112 set in the setting register 202. Thus, not only the updated data Rk, but also the original data Dk are stored in the flash memory 110 at least until the updated data Rk is stored in the flash memory 110, even when the original data Dk is not necessary after the update. As a result, the original data Dk is never lost during the update, thereby achieving stable and efficient data transfer.

On the other hand, when the original data Dk is not data to be updated, the address Ak does not match any one of the addresses Ai to Aj (Step S702: No). In this case, the selector 503 connects the flash memory 110 and the sequencer 201, so that the data Dk stored at the address Ak in the source sector 111 of the flash memory 110 is read and stored in the data register 203 (Step S704).

Then the process proceeds to Step S604 shown in FIG. 6. In the process following Step S604, the data Dk stored in the data register 203 is transferred to the address Ax of the destination sector 112 set in the setting register 202. Thus, the data Dk is transferred stably without being lost before the transfer of data Dk is completed.

According to the second embodiment, stable data transfer is achieved in which data will be never lost, because the original data Dk or the updated data Rk is read and stored in the data register 203 of the data transfer device 400, and because the original data Dk is stored in the source sector 111 until the updated data Rk is stored in the destination sector 112.

Furthermore, the sequencer 201 controls the switch-over between the read mode and the write mode of the flash memory 110 using the write-enable signal WE. Moreover, the command generator 204 issues the write command when data is written in the flash memory 110. Thus, data transfer/update processing can be performed without involving the CPU 200, thereby increasing the efficiency of data transfer/update. Moreover, a speed-up of data transfer/update is achieved because the occupation of bus 220 by the CPU 200 is reduced.

Moreover, the burden on the CPU 200 is reduced because whether data stored at a certain address in the source sector is to be transferred as it is to the destination sector or to be updated and transferred to the destination sector is determined based on the address, due to the ROM correction function implemented by the database 501, the comparator 502, and the selector 503.

As described above, according to the second embodiment, the data transfer between different sectors within the same flash memory 110 can be performed stably and efficiently.

According to the data transfer device and the data transfer method according to the present invention, the burden on CPU can be reduced and a transfer program can be simplified, while stable and efficient data transfer and data update can be achieved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data transfer device for transferring data from a first sector of a flash memory to a second sector of the flash memory, the data transfer device comprising:
a reading unit that reads data from the first sector; and
a writing unit that writes the data read by the reading unit in the second sector.

2. The data transfer device according to claim 1, further comprising a control unit that switches a mode of the flash memory from a read mode to a write mode when the reading unit finishes reading the data from the first sector, and switches the mode of the flash memory from the write mode to the read mode when the writing unit finishes writing the data in the second sector.

3. The data transfer device according to claim 1, wherein the reading unit reads another data from the first sector when the writing unit finishes writing the data in the second sector.

4. The data transfer device according to claim 1, further comprising:
a storing unit that stores an address at which a first data is stored in the first sector and a second data corresponding to the first data; and
a determining unit that determines whether a designated address matches the address stored in the storing unit, wherein
the reading unit reads the first data from the first sector or reads the second data from the storing unit, based on a result of determination performed by the determining unit.

5. The data transfer device according to claim 4, wherein the reading unit reads the first data from the first sector when the determining unit determines the designated address does not match the address stored in the storing unit, and reads the second data from the storing unit when the determining unit determines the designated address matches the address stored in the storing unit.

6. A data transfer device for transferring data from a first sector of a flash memory to a second sector of the flash memory, wherein a first data is stored in the first sector, the data transfer device comprising:
a storing unit that stores a second data that is an updated data of the first data;
a reading unit that reads the second data from the storing unit; and
a writing unit that writes the second data read by the reading unit in the second sector.

7. A method of transferring data from a first sector of a flash memory to a second sector of the flash memory, the method comprising:
reading data from the first sector; and
writing the data read at the reading in the second sector.

8. The method according to claim 7, further comprising switching a mode of the flash memory from a read mode to a write mode when the reading is finished, and switches the mode of the flash memory from the write mode to the read mode when the writing is finished, wherein
the data is written in the second sector when the mode of the flash memory is switched to the write mode.

9. A method for transferring data from a first sector of a flash memory to a second sector of the flash memory, wherein a first data is stored in the first sector, the method comprising:
storing a second data that is an updated data of the first data in a database;
reading the second data from the database; and
writing the second data read at the reading in the second sector.
